(19) United States
(12) Patent Application Publication
(10) Pub. No.: US 2025/0305216 A1
(43) Pub. Date: Oct. 2, 2025

(54) FIBER-BASED FOOD CONTAINERS FOR EMULSIONS

(71) Applicant: Footprint International, LLC, Gilbert, AZ (US)

(72) Inventors: Yoke Chung, Gilbert, AZ (US); Kolbe Scheetz, Mesa, AZ (US)

(21) Appl. No.: 19/096,213

(22) Filed: Mar. 31, 2025

Related U.S. Application Data
(60) Provisional application No. 63/573,100, filed on Apr. 2, 2024.

(51) Int. Cl. D21H 11/04; B31B 50/74; B31B 110/35; B65D 1/26; D21H 17/28; D21H 19/82; D21H 21/16

(52) U.S. Cl. CPC D21H 11/04; B31B 50/74; B65D 1/26; D21H 17/28; D21H 19/82; D21H 21/16; B31B 2110/35

(57) ABSTRACT

Systems and methods are described for fiber-based, plastic-free products for storage of emulsion food products. In some embodiments, a coating is applied to the product, such as a coating comprising efficacious proportions of xylitol, citric acid, water, microfibrillated cellulose, and polyvinyl alcohol. A slurry is used to fabricate the product includes various proportions of fiber blends (e.g., combinations of bleached softwood, bleached hardwood, kraft paper, and/or virgin fiber), AKD, starch, a stearate (e.g., Magnesium or Calcium Stearate), a defoamer, and microfibrillated cellulose.

### CROSS-REFERENCES TO RELATED APPLICATIONS

This application claims priority to U.S. Patent Application No. 63/573,100 filed Apr. 2, 2024.

### TECHNICAL FIELD

The present technology relates, generally, to the manufacture of plastic-free, fiber-based food container products and, more particularly, to designs, chemistry, and tooling for forming containers adapted to the storage of emulsions.

### BACKGROUND

Molded fiber is a packaging material typically made from a pulp of recycled paperboard and is considered an environmentally sustainable packaging option. Molded pulp manufacturing has experienced increased popularity in recent years in a wide range of applications, including, for example, cups, bowls, straws, and the like. Fiber-based packaging products are biodegradable, compostable and, unlike plastics, do not migrate into the ocean.

Molded fiber processing can generally be categorized as either “wet” or “dry”. The two most common types of “wet” molded pulp are classified as Type 1 and Type 2. Type 1 wet molded pulp manufacturing, also referred to as “wet-laid forming,” uses a fiber slurry made from ground newsprint, kraft paper or other fibers dissolved in water. A mold mounted on a platen is dipped or submerged in the slurry and a vacuum is applied to the generally convex backside. The vacuum pulls the slurry onto the mold to form the shape of the package. While still under the vacuum, the mold is removed from the slurry tank, allowing the water to drain from the pulp. Air is then blown through the tool to eject the molded fiber piece. The part is typically deposited on a conveyor within a drying oven.

Type 2 wet molded pulp manufacturing is typically used for packaging electronic equipment, cellular phones and household items with containers having particular wall dimensions. Type 2 molded pulp uses the same material and follows the same basic process as Type 1 manufacturing up the point where the vacuum pulls the slurry onto the mold. After this step, a transfer mold mates with the fiber package, moves the formed “wet part” to a hot press, and compresses and dries the fiber material to increase density and provide a smooth external surface finish.

Unlike wet molded pulp manufacturing, dry processing of mold pulp products does not use a wet slurry, but instead employs substantially dry pulp materials used to form a dry web that is then pressed to create molded products. For example, air-laid webs are produced by mixing fibers with air to form a uniform air fiber mixture which is then pressed or vacuum-pulled into a flat blank.

### SUMMARY

The present subject matter relates to methods and systems for producing fiber-based, plastic-free products (e.g., containers) adapted for storage of food emulsions, e.g., water-in-oil (W/O) emulsions, such as margarine, butter, mayonnaise, and the like. In various embodiments, the fiber-based products disclosed herein have hydrophobic and oleophobic properties to avoid absorption of foods stored therein. In these and other embodiments, the fiber-based products disclosed herein are made with materials that provide non-stick and/or non-staining properties. The hydrophobic, oleophobic, non-stick, and/or non-staining properties provide for a shelf-stable storage containers of water/oil (W/O) emulsions, without negating the compostable nature of the fiber-based product.

In some embodiments, one or more coatings are applied to the fiber-based products to increase their resistance to water and/or oils and/or otherwise enhance select properties of the formed products. These coatings can comprise efficacious proportions of xylitol, citric acid, water, microfibrillated cellulose, and polyvinyl alcohol. In some embodiments, the coating can include an acrylic copolymer latex (e.g., RHOBARR 214 manufactured by Dow Inc. of Midland, MI), pectin, microfibrillated cellulose, and/or defoamer. In some embodiments, the coating is omitted. In various embodiments, a slurry is used to fabricate the product, and includes various proportions of fiber blends (e.g., combinations of bleached softwood, bleached hardwood, kraft paper, and/or virgin fiber), AKD, starch, a stearate (e.g., magnesium or calcium stearate), a defoamer, and/or microfibrillated cellulose.

Various features and characteristics will also become apparent from the subsequent detailed description and the appended claims, taken in conjunction with the accompanying drawings and this background section

### BRIEF DESCRIPTION OF THE DRAWING

Exemplary embodiments will hereinafter be described in conjunction with the appended drawing figures, wherein like numerals denote like elements, and:

FIGS. 1A-1C illustrate top, isometric, and side views, respectively, of an emulsion product container in accordance with various embodiments;

FIG. 2 is a flowchart depicting a method of forming an emulsion product container in accordance with various embodiments; and

FIGS. 3A-3E are conceptual views illustrating the processing of an emulsion product container in accordance with various embodiments;

### DETAILED DESCRIPTION

Aspects of the present subject matter are generally directed to advanced systems and methods for producing fiber-based, plastic-free products adapted for storage of food emulsions, e.g., water-in-oil (W/O) emulsions such as margarine, butter, mayonnaise, and the like. This is accomplished using intrinsic chemistry—adding oleophobic and hydrophobic additives to a pulp mixture prior to wet-forming—and/or the application of surface coatings to the product container.

While the disclosed embodiments are primarily directed to the production of paper-based packaging products for emulsions, it is understood that paper-based packaging products are used as an example and the disclosed methods and systems can be implemented or adapted to produce a wide variety of fiber-based products presently known or later developed, including but not limited to quick-serve restaurant (QSR) paper plates, trays, clamshell boxes, bowls, and cups; hot/cold drinking paper cups; packaging materials for frozen, refrigerated, microwaveable, and oven-heated food containers; dairy fiber packages, and the like.

The terminology used in the description below is intended to be interpreted in its broadest reasonable manner, even though such terminology may be used in conjunction with a detailed description of certain specific embodiments of the disclosure. Certain terms may be emphasized below; however, any terminology intended to be interpreted in any restricted manner will be clearly and unambiguously defined as such in this Detailed Description.

The accompanying figures depict embodiments of the present technology and are not intended to be limiting of its scope. The sizes of various depicted elements are not necessarily drawn to scale, and these various elements can be arbitrarily enlarged to improve legibility. Component details can be abstracted in the figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

### Emulsion Products

Various embodiments of the present subject matter are directed to product containers configured for the storage of emulsion products and to address the particular challenges presented by such products. In this regard, the term “emulsion product” refers to any fine dispersion of small droplets of one liquid in another liquid in which it is not soluble or miscible. Food emulsions may be classified as water-in-oil (such as butter, margarine, hybrid butter/oil spreads, and the like), or oil-in-water (such as milk and cream).

In particular, margarine, as a water-in-oil emulsion, contains tiny droplets of water dispersed uniformly through a fat phase in stable solid form, and is typically about 80% fat and up to 16% water. Margarines may also include other ingredients such as salt, coloring, natural/artificial flavorings, and other vegetable oils, such as soybean, corn, palm, canola, and olive. The use of pulp-based, plastic-free containers to store margarine is particularly challenging due to the presence of both water and oil, and the expected shelf-life of the product.

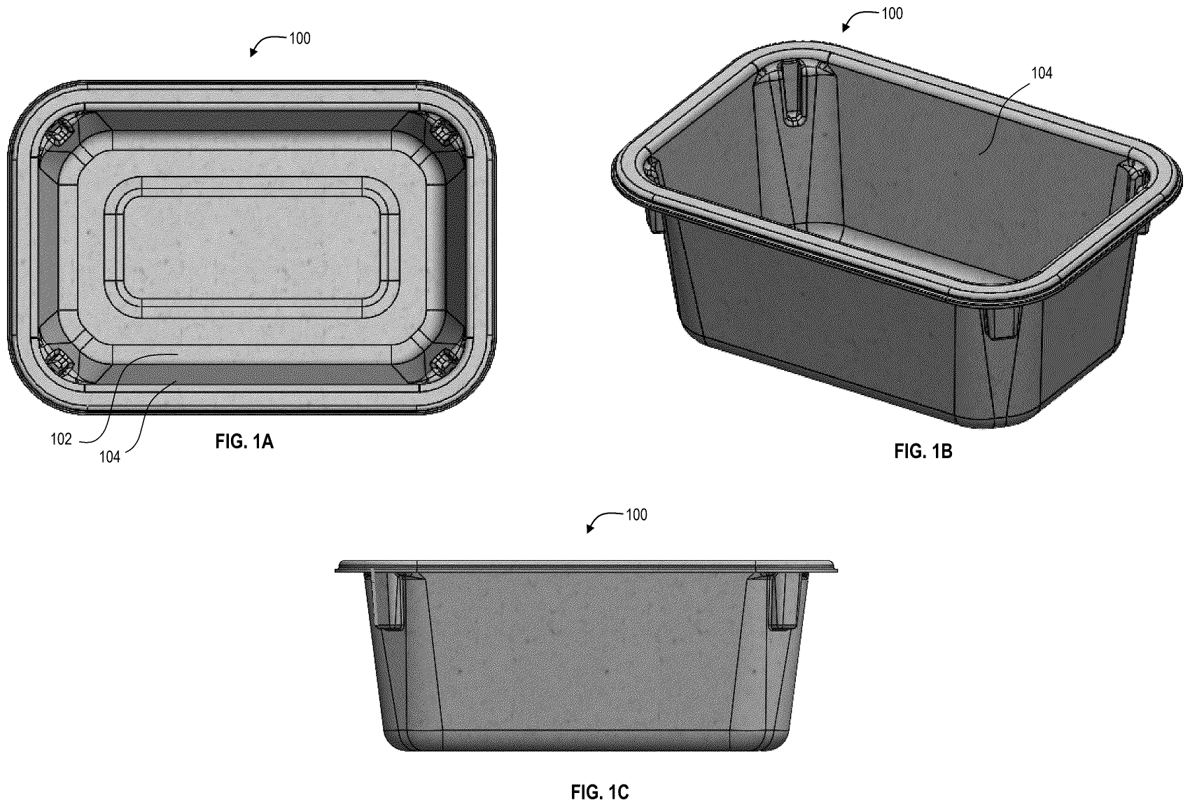

FIGS. 1A-1C illustrate top, isometric, and side views, respectively, of an emulsion product container in accordance with various embodiments. As shown, container 100 generally includes a bottom inner surface 102 and a beveled or angled sidewall 104 leading to an upper lip configured to engage a lid component or support a top surface attached thereto (not shown). As described below, the inner surfaces (102, 104) may be coated to provide additional oleophobic and hydrophobic properties, in addition to the intrinsic properties of container 100 provided by various slurry additives (also described in detail below). It will be appreciated that FIGS. 1A-1C may not be drawn to scale, and that the embodiment shown is not intended to limit the range of geometries that may be used for the emulsion product container.

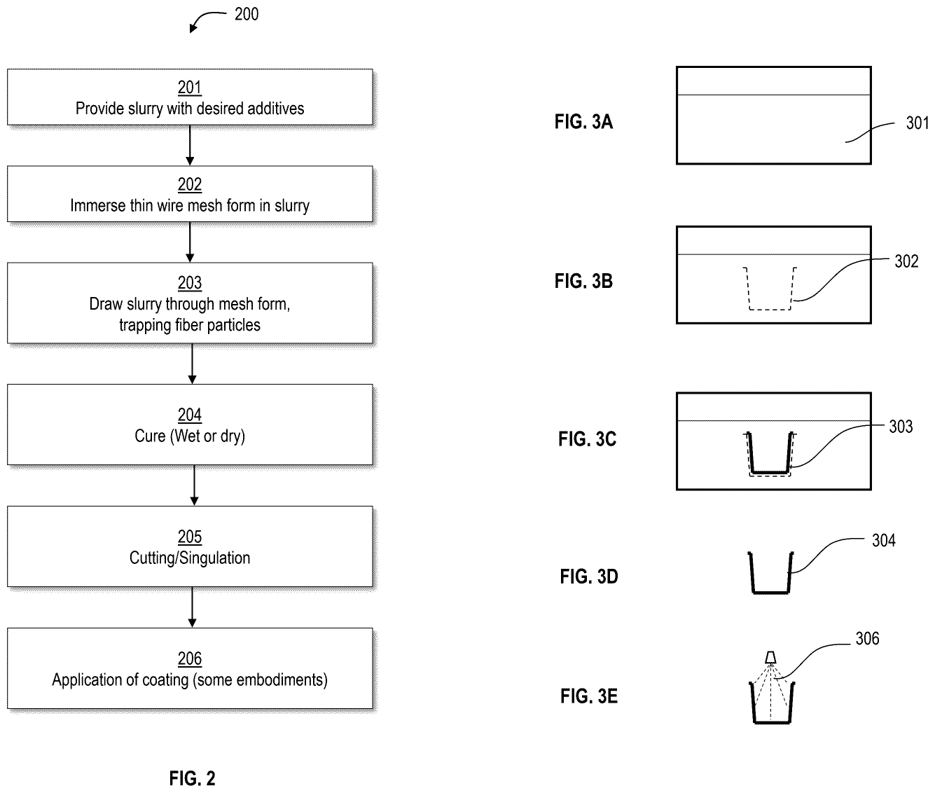

FIG. 2 is a flowchart depicting a method of forming an emulsion product container of FIGS. 1A-1C in accordance with various embodiments, and FIGS. 3A-3E are conceptual views illustrating the processing of an emulsion product container in accordance with various embodiments. More particularly, referring to FIG. 2 in combination with FIGS. 3A-3B, processing begins with the preparation of a slurry 301 containing various fiber blends and additives as described below. A thin wire mesh 302 in the general shape of one or more units of the desired product container is then at least partially immersed in slurry 301 (step 202). The slurry is suitably drawn—e.g., through a differential pressure, drawing a vacuum-through the mesh form, trapping fiber particles on the surface of wire mesh 302 (step 203) and causing the fiber particles to accumulate on the wire mesh 302 to form the shape of the product container. Subsequently, the wire form 302 with the accumulated fiber formed thereon is removed from the slurry 301 (e.g., while still under vacuum) and then cured-through a wet or dry process, as will be understood by those skilled in the art (step 204). After cutting and/or singulation (step 205), a coating 306 may be applied to the finished product to further enhance its barrier performance (step 206).

### Fiber-Blends

Product containers in accordance with the present subject matter may be manufactured using a wide range of fiber blends and other constituent materials, and may be either wet-formed or dry-formed. That is, while the present subject matter is directed primarily to wet-forming product containers for emulsions, various dry-forming techniques may be employed, an example of which is described in U.S. Prov. Pat. No. 63/609,922, filed 14 Dec. 2023, entitled “Systems and Methods for Web-Fed Dry Forming of Fiber-Based Products,” the contents of which are incorporated by reference.

Suitable fiber types applicable to the present subject matter include: (1) cellulose fibers, such as fluff web or pulp webs; (2) biowaste or agriculture waste, such as chitosan flakes, rice hulls, wheat or other grain straws, sugar cane bagasse, and the like; and (3) virgin and recycle fibers such as kraft, card stock, poster board, and the like.

In various embodiments, the fiber-based slurry mixture includes select amounts of virgin newsprint, bleached softwood, bleached hardwood, and/or unbleached kraft paper. In some embodiments, for example, the slurry includes an amount of virgin newsprint approximately equal to 30% to 50% by weight, an amount of softwood (e.g., bleached softwood) approximately equal to 30-40% by weight, and an amount of kraft paper (e.g., unbleached kraft paper) approximately equal to 20-30% by weight. In some embodiments, the slurry includes an amount of bleached hardwood approximately equal to 30% to 50% by weight, an amount of bleached softwood approximately equal to 30-40% by weight, and an amount of unbleached kraft paper approximately equal to 20-30% by weight. In some embodiments, the percentage of virgin newsprint, softwood, hardwood, and/or kraft paper in the slurry may differ. In some embodiments, the virgin newsprint, softwood, hardwood, and/or kraft paper may be omitted from the slurry and/or different fiber materials may be included in the slurry mixture.

With respect to product containers for emulsions that do not include coatings, it has been found by the present inventors that a mixture (expressed as percent dry weight) containing about 40% virgin newsprint, about 35% bleached softwood, and about 25% unbleached kraft paper is particularly effective. In other embodiments, 100% virgin fiber or a mixture of virgin fiber and recycled fiber may be used.

In some embodiments, the target pH for the pulp ranges from 4.0 to 12.0, e.g., preferably from 8.0 to 10.0 for emulsion products. This pH will vary depending upon the nature of the pulp material and additives dispensed during conditioning. Note that, through experimentation, the internal chemistry, pH, and other intrinsic characteristics of the finished product can be correlated to the process parameters used to manufacture the product container.

With respect to product containers that do include a coating (such as the polyvinyl-alcohol-based coating described below), the fiber blends may include any combination of virgin and recycled fiber, or in some embodiments a fiber blend that includes about 45% bleached softwood, about 25% bleached hardwood, and 30% unbleached kraft pulp.

### Additives

Additives may be incorporated into, placed on the surface of, or otherwise incorporated into the product container (e.g., dispensed within the fiber slurry, coated on the base material of the formed container) to achieve a variety of objectives, which will generally depend on the geometry of the product container, the use-case (microwaved, frozen, etc.), and the food product that is being contained, among other factors. The additives may, for example, be introduced into the pulp-based slurry prior to wet-forming, and/or may be introduced through the application of a coating (e.g., through spray-coating). In some embodiments, both surface additives and additives incorporated into the fiber base material (e.g., slurry mixture) may be employed to achieve the desired additive chemistry profile throughout the finished product.

Additives include, for example, strengtheners, water proofing agents, hydrophobic additives, oleophobic additives, water vapor barriers, and oxygen barriers. In general, the phrase “barrier additive” refers to any additive that provides resistance to the absorption (in the finished product) of water, oil, water vapor, oxygen, a mixture thereof, or any other material that might negatively impact the quality or reliability of the finished product.

As a preliminary matter, the fiber percentages described herein are based on the dry mass of fiber that is added, and the internal chemistry percentages are based on the mass percent of the dry active ingredient with respect to the total mass of the fiber in the batch. Note that some ingredients are manufactured as emulsions or dispersions with different concentrations from different suppliers. For spray coatings, the percentages are based on dry mass of active component with the exceptions of water (based on total mass of water added), which may be adjusted based on the form in which it is received from the supplier.

A wide range of coatings may applied to the surface of the product container, including the additives described herein as well as other additives that are particularly efficacious with respect to oil and water resistance when applied to the molded surface.

In some embodiments, for example, a polyvinyl-alcohol-based coating is used, which adds resistance to liquid water, is oleophobic, and is capable of a water vapor transmission rate (WVTR) of less than 5.0 g/100 in²·24 hrs. under standard conditions. This coating may be applied in a variety of ways, including for example spray coat, flooding, blade coating, and the like. This formulation may also provide non-stick and non-staining property to the formed product, and is particularly useful in context that require both water and oil barrier performance in ambient, hot, or frozen conditions.

In some embodiments, the coating includes 0-10% xylitol (and/or other sugar alcohol), 0.1-10% citric acid, 78-92% water, 0-12% microfibrillated cellulose, and 1-10% polyvinyl alcohol. In another embodiment, the coating includes 0.5-6.0% xylitol, 0.25-4.0% citric acid, 80-90% water, 3-9% microfibrillated cellulose, and 2-7% polyvinyl alcohol. In another embodiment, the coating includes 1.5-3.5% xylitol, 0.5-2.0% citric acid, 82-88% water, 5-7% microfibrillated cellulose, and 3-6% polyvinyl alcohol.

Strength additives, which generally function to enhance structural rigidity, may be incorporated into the product container in accordance with various embodiments. Strength additives include, for example, liquid starches available commercially as Topcat® L98 cationic additive, Hercobond® in a range of 0.1% to 5%, e.g., preferably 0.5% to 2.5% for some implementations, and for some implementations be about 2.0%+1%. Alternatively or in addition, the liquid starch may be combined with low charge liquid cationic starches such as those available as Penbond® cationic additive and PAF 9137 BR cationic additive to achieve the range of 0.1% to 5%, e.g., preferably 0.5% to 2.0% for some implementations. To increase the dry strength, the paper web 150 may be conditioned with other starches. Examples include polyamide-epichlorohydrin (PAE) resins, such as Kymene 920A, Kymene 1500, or other wet strength additives to achieve the range of 0.1% to 5%, e.g., preferably 0.5% to 2.0% for some implementations.

With respect to product containers for emulsions in which the container does not include a coating, it has been found by the present inventors that a slurry mixture including a starch additive at about 2.5% by weight is particularly effective. In other embodiments, slurry mixtures with up to 5% starch or up to 30% starch have been found to be effective.

With respect to product containers that do include a coating (such as the polyvinyl-alcohol-based coating described above), slurry mixtures including about 0-5% by weight of starch additive have been found effective. In some embodiments, it has been found effective to have slurry mixtures with 0.25-1.25% by weight of starch additive. In other embodiments, it has been found effective to have slurry mixtures including 0.5-1.0% by weight of starch additive.

In some embodiments, microfibrillated cellulose and/or defoamer are added. In some embodiments, 0-1% defoamer and 0-50% microfibrillated cellulose are used, in others 0-0.5% defoamer and 5-20% microfibrillated cellulose is added, and in other embodiments, 0.1-0.3% defoamer and 10-16% microfibrillated cellulose is added.

Barrier Additives may be incorporated into the product container in accordance with various embodiments. For example, stearate salts, such as zinc stearate and/or magnesium stearate, have been found to add both hydrophobic and oleophobic properties to the finished product.

With respect to product containers for emulsions in which the container does not include a coating, it has been found that the addition of 15% by weight of magnesium stearate is particularly effective. In other embodiments, a range of 10-20% of magnesium stearate or zinc stearate is employed. In other embodiments, the stearate additives are dispensed to achieve between 1.0-20.0% stearate salt internal/external chemistry. For example, zinc stearate and/or magnesium stearate are dispensed to achieve between 5%-20% stearate chemistry internally or on the surface.

With respect to product containers that do include a coating (such as the polyvinyl-alcohol-based coating described above), it has been found to be effective to include about 2-25% stearate in some embodiments, 5-15% stearate in other embodiments, and 8-12% stearate in yet other embodiments.

In some embodiments, such as for non-single-use products, an alkylketene dimer (AKD), and/or long chain diketenes, alkyl succinic anhydride (ASA) and/or some wax may be included as an additional moisture/water barrier. These additives may be dispensed to achieve approximately a 2-50% internally or externally, e.g., preferably 1%-5% for some implementations, and for some implementations be about 2.3%+1%. In the context of product containers for emulsions, it has been found by the present inventors that low levels (about 0%-1%) of AKD can be particularly effective.

The one or more hydrophobic and/or oleophobic additives may also or alternatively include polysaccharides, such as NCC, pectin, and alginate, which have been found to add hydrophobic and/or oleophobic as well as water vapor and oxygen barrier properties to the product. In some embodiments, polysaccharides are dispensed to achieve between 5%-25% internal or external, chemistry. In select embodiments, for example, polysaccharide additives are dispensed to achieve approximately a 10%-15% polysaccharides internally or externally. In some embodiments, a crosslinker such as Citric Acid or Malic acid can be added for better barrier performance. In some embodiments, a plasticizer such as xylitol, polyglycerol might also be added for extra flexibility.

The one or more additives can include one or several proteins or a combination of polysaccharides and protein, which have been found to add hydrophobic and/or oleophobic as well as water vapor and oxygen barrier properties to the product. Examples include casein, zein (corn protein), and the like that are sprayed or otherwise deposited across regions of the product to provide a wide-spread water vapor barrier and/or oxygen barrier. In some embodiments, the proteins or protein combinations are dispensed to achieve approximately a 1%-20% internally or externally, e.g., preferably 5%-15% for some implementations.

In various embodiments, the one or more additives may include one or more fillers that add hydrophobic and/or oleophobic properties, as well as water vapor and oxygen barrier and strength properties, to the product. These fillers can include, for example: clay, MFC, MCC, and/or CNF. For some implementations, proteins are dispensed to achieve approximately a 1%-20% internally or externally, e.g., preferably 2.5%-10%. The fillers can be impregnated or otherwise added inside to product itself to make the product denser and less porous. In some embodiments, the fillers may be disposed (e.g., sprayed) on a surface of the product. In some embodiments, the conditioning process can include disposing fillers as well as proteins such that they can operate together to provide oxygen or water vapor barrier properties.

In various embodiments, the one or more additives may include water soluble polymers to serve as strength additives or stabilizing agents. These polymers can include polyvinyl alcohol (PVA), modified starch, carboxymethyl cellulose (CMC), with and without crosslinkers and/or plasticizers. Those polymers may be dispensed to achieve approximately a 1%-25% internally or externally, e.g., preferably 2.5%-15% for some implementations.

In many cases, the techniques relating to additives, paper composition, processing, spray-coating, and the like for wet molding may apply to dry molding in accordance with the present technology. In that regard, the systems and methods described above may incorporate by reference the disclosures of the following patent documents in their entirety and for all purposes: U.S. Pat. Pub. No. 2020/0206984, “Methods, Apparatus, and Chemical Compositions for Selectively Coating Fiber-Based Food Containers,” U.S. Pat. No. 10,428,467, “Methods and Apparatus for Manufacturing Fiber-Based Meat Products,” U.S. Pat. No. 9,988,199, “Methods and Apparatus for Manufacturing Fiber-Based Microwavable Food Containers,” U.S. Pat. No. 10,036,126, “Methods for Manufacturing Fiber-Based Beverage Lids,” U.S. Pat. No. 10,124,926, “Methods and Apparatus for Manufacturing Fiber-Based, Foldable Packaging Assemblies,” U.S. Pat. No. 9,856,608, “Methods for Manufacturing Fiber-Based Product Containers,” U.S. Pat. No. 10,087,584, “Methods and Apparatus for Manufacturing Fiber-Based Meat Containers,” U.S. Pat. No. 9,869,062, “Method for Manufacturing Microwavable Food Containers,” U.S. Pat. No. 10,377,547, “Method and Apparatus for In-line Die Cutting of Vacuum Formed Molded Pulp Container,” U.S. Pat. No. 10,240,286, “Die Press Assembly for Drying and Cutting Molded Fiber Parts,” and U.S. Pat. No. 10,683,611, “Method for Simultaneously Pressing and Cutting a Molded Fiber Part.”

The foregoing manufacturing methods have been found by the present inventors to be particularly effective empirically—for example, through the use of a modified Cobb test in which the absorption of the target emulsion (and oil itself) is minimized. The range of possible embodiments is not so limited, however, and any of the ranges provided above in the Detailed Description may be employed to implement particular applications.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

The above detailed description of embodiments of the technology is not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, although steps are presented in a given order, alternative embodiments can perform steps in a different order. The various embodiments described herein can also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms can also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration but that various modifications can be made without deviating from the technology. Further, while advantages associated with some embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method of manufacturing a fiber-based container for emulsions, comprising:
preparing a fiber-based slurry mixture including a stearate salt having both oleophobic and hydrophobic properties;
providing a wire mesh corresponding to a shape of the fiber-based container;
at least partially immersing the wire mesh into the fiber-based slurry mixture;
drawing a vacuum across the wire mesh to cause fiber particles of the fiber-based slurry mixture to accumulate at a surface of the wire mesh;
removing the wire mesh including the accumulated fiber particles from the fiber-based slurry mixture such that the accumulated fiber particles are in the shape of the fiber-based container; and
at least partially drying the fiber-based container.

2. The method of claim 1, wherein the stearate salt comprises at least one of magnesium stearate and zinc stearate.

3. The method of claim 1, wherein the stearate salt comprises magnesium stearate in an amount equal to approximately 10-20% by weight.

4. The method of claim 3, wherein the stearate salt comprises magnesium stearate in an amount equal to approximately 15% by weight.

5. The method of claim 1, wherein the fiber-based slurry includes approximately 1%-5% by weight of a starch additive.

6. The method of claim 5, wherein the fiber-based slurry mixture includes approximately 2.5% by weight of starch additive.

7. The method of claim 1, wherein the fiber-based slurry mixture includes approximately 30%-50% of bleached kraft softwood, approximately 30%-40% bleached kraft hardwood, and approximately 20%-30% unbleached kraft paper.

8. The method of claim 1, further including applying a coating to at least a portion of the fiber-based container.

9. The method of claim 8, wherein the coating is a polyvinyl-alcohol-based coating.

10. The method of claim 9, wherein the coating includes about 1.5%-3.5% xylitol, 0.5% citric acid, 82-88% water, 5-7% microfibrillated cellulose, and 3-6% polyvinyl alcohol.

11. The method of claim 8, wherein the fiber-based slurry mixture further includes about 0.1-0.3% defoamer.

12. The method of claim 8, wherein the fiber-based slurry mixture further includes about 10-16% microfibrillated cellulose.

13. A fiber-based container for storing emulsions, the fiber-based container comprising:
a base structure defining a receptacle configured to carry an emulsion and an inner surface configured to contact the emulsion, wherein the base structure comprises:
a cellulose fiber material; and
a stearate salt,
wherein the fiber-based container has both oleophobic and hydrophobic properties.

14. The fiber-based container of claim 13, wherein the stearate salt comprises at least one of magnesium stearate and zinc stearate.

15. The fiber-based container of claim 13, wherein the base structure further comprises a starch additive at an amount equal to 0.4%-0.7% by weight.

16. The fiber-based container of claim 13, further comprising a coating disposed on the inner surface of the base structure, wherein the coating has oleophobic properties, non-stick properties, and non-staining properties, and wherein the coating has a water vapor transmission rate (WVTR) of less than 5.0 g/100 in².

17. The fiber-based container of claim 16, wherein the coating is a polyvinyl-alcohol-based coating.

18. The fiber-based container of claim 16, wherein the coating comprises about 0.1%-5% by weight xylitol, 0.1%-1.5% by weight citric acid, and 2-12% by weight polyvinyl alcohol.

19. The fiber-based container of claim 18, wherein the coating further comprises 0.75%-1.5% by weight microfibrillated cellulose.

20. The fiber-based container of claim 13, further comprising a coating including an acrylic copolymer latex at an amount equal to 50%-80% by weight, pectin at an amount equal to 0.5%-2% by weight, and microfibrillated cellulose.
